(19) United States
(12) Patent Application Publication
(10) Pub. No.: US 2025/0037130 A1
(43) Pub. Date: Jan. 30, 2025

(54) COMPUTER SYSTEMS AND METHODS FOR VERIFYING AND AUTHENTICATING CROSS BORDER PAYMENTS

(71) Applicant: The PNC Financial Services Group, Inc., Pittsburgh, PA (US)

(72) Inventors: Greg Bolanos, Port Saint Lucie, FL (US); Akshay Ahluwalia, Port Saint Lucie, FL (US)

(21) Appl. No.: 18/207,928

(22) Filed: Jun. 9, 2023

(51) Int. Cl. G06Q 20/40; G06N 20/00; G06Q 20/10

(52) U.S. Cl. CPC G06Q 20/4016; G06N 20/00; G06Q 20/108; G06Q 20/02

(57) ABSTRACT

Computer systems and computer-implemented methods train a machine learning model to authenticate a payment transfer between a payer and a payee. Training the machine learning model comprises training data such as pre-validation data for payment transactions from an intra-bank payment network, compliance data, and user transaction history. Authenticating the payment comprises receiving, by a deployment computer system, the proposed wire payment from the payer, obtaining a first set of pre-validation data for the proposed wire payment from the intra-bank payment network, obtaining a second set of pre-validation data via internal compliance databases. Authenticating the payment further comprises determining a genuineness score for the proposed wire payment based on the first set of data and the second set of data using the machine learning model and providing a recommendation for the proposed wire payment to the payer based on the genuineness score.

### BACKGROUND

ISO 20022 provides an open global standard for electronic data interchange between financial institutions. ISO 20022 also provides for a data rich common language to facilitate payment instructions among financial institutions. FRAML is an innovative combined approach to fraud prevention and anti-money laundering activities that benefits financial institutions by allowing financial institutions to address both issues using a holistic approach.

### SUMMARY

In one general aspect, the present invention is directed to computer systems and computer-implemented methods for authenticating a proposed wire payment between a payer and a payee by a novel authentication process. The computer system trains a machine learning model (ML model) to compute genuineness scores for wire payments in training data and then, once trained, can be deployed to compute a genuineness score for a proposed wire payment. The training data can comprise data, such as pre-validation data, from an intra-bank payment network, such as SWIFT®, that can be obtained through API calls to the SWIFT intra-bank payment network. The training data can also include a second set of data, such as data from internal compliance document databases from a financial institution.

The ML model is configured to generate a genuineness score as part of the authentication process. The authentication process comprises receiving the proposed wire payment, obtaining a first set of pre-validation data from the intra-bank payment network and obtaining a second set of pre-validation data from internal compliance databases from a financial institution. The authentication process further comprises determining a genuineness score based on the first set of pre-validation data and the second set of pre-validation data by way of a deployment computer system that deploys the ML model. Determining the genuineness score involves using the ML model, as will be discussed in greater detail below.

Systems according to the present invention provide significant benefits. For example, authenticating a proposed wire payment can proactively identify expensive errors. Also, fraudulent activities are detected in an efficient manner by the systems described herein. The proactive nature of the systems described herein ultimately reduces overall cycle time required to initiate and complete cross border payments. As a result, the systems described herein save financial institutions and customers time as well as money. The systems provide an extra layer of security while increasing efficiency. These and other benefits that can be realized through embodiments of the present invention will be apparent from the description that follows.

### FIGURES

Various embodiments of the present invention are described herein by way of example in connection with the following figures.

FIGS. 1 is a diagram of a system, including various computer systems, for authenticating a payment between a payer and a payee, according to various embodiments of the present invention.

FIG. 2 is an illustration of a sequence of the system of FIG. 1 according to various embodiments of the present invention.

FIG. 3A is an illustration of a financial institution interface depicting a generated genuineness rating according to various embodiments of the present invention.

FIG. 3B is an illustration of a user interface depicting a generated genuineness rating according to various embodiments of the present invention.

FIG. 4 is an illustration of a process flow of the system of FIG. 1 according to various embodiments of the present invention.

FIG. 5 is a diagram of a deployment computer system according to various embodiments of the present invention.

### DESCRIPTION

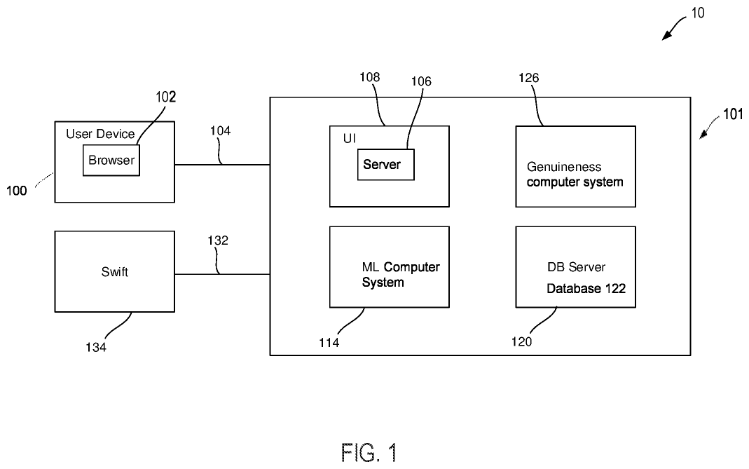

FIG. 1 is a diagram of an inter-networked set of computer systems 10 for collectively authenticating a payment, particularly a wire payment, using machine learning. The inter-network set of computer systems 10 comprises a user device 100 (e.g., a mobile device, laptop, etc.) and user for the user device can be the person/entity seeking to make the wire payment. The set also comprises a bank computer system 101 and intra-bank payment network 134, such as the SWIFT® intra-bank payment network 134.

The bank computer system 101 can comprise a web server 106 or other application server for communicating with the user device 100. In that connection, the user device 100 may comprise a browser, preferably one that supports Javascript® 102, for communicating with the web server 106 via hypertext transfer (or transport) protocol (HTTP) communications 104. In particular, the user, via the user device 100, can seek to initiate, and then review, a wire transfer payment to be made via the bank corresponding the bank computer system 101. The web server may, therefore, provide a user interface (UI) 108, which includes a payment interface 110, for the user to initiate the wire payment.

The bank computer system 101 can also comprise a first (“genuineness”) computer system 126 for communicating with the web server 106 and orchestrating computation and communication of the genuineness score for a proposed wire payment from the user; a second (“ML”) computer system 114 that comprises a ML model that is trained to compute a genuineness score for the proposed wire payment; and a database server 120 for storing transaction data for prior transactions involving the bank, or other financial institution, that is computing the genuineness score or rating. The web server 106 and the genuineness computer system 126 can communicate via HTTP communications 112 (not shown). For example, when a user initiates a wire payment, the web server 106 can capture the details for the proposed wire payment (e.g., the payer, the payee, and the amount) and pass that information to the genuineness computer system 126. The genuineness computer system 126 can in turn orchestrate computation of the genuineness score for the proposed wire payment and transmit the results from the genuineness determination to the web server 106 for delivery to the user device 100.

The ML computer system 114 trains, and then implements, the ML model as described herein. The ML computer system 114 communicates with the genuineness computer system 126 via a set of risk modeling APIs 132, for example, via HTTP communications.

The SWIFT® intra-bank payment network 134 is a messaging network used by financial institutions to securely complete transactions among financial institutions. As described herein, the genuineness computer system 126 may make API calls to the SWIFT® network 134 in order to collect information used in the genuineness analysis for the proposed wire payment. The API calls may comprise, for example, calls via pre-validation APIs to the SWIFT network 134. In particular, various embodiments of the genuineness computer 126 may use of the following SWIFT® pre-validation APIs calls: swift-preval-pilot/v2/payment/account-format, swift-preval-pilot/v2/accounts/verification, swift-preval-pilot/v2/payment/financial-institution-identity, swift-preval-pilot/v2/payment/purpose-code, swift-preval-pilot/v2/payment/payment-purpose, and swift-preval-pilot/v2/payment/category-purpose. The API calls may also comprise compliance-analytics API calls to the SWIFT network, such as the API call: compliance-analytics/v1/institution-review.

The database server 120 may comprise, and serve data from, a database 122 that stores data related to, among other things, prior transactions by customers of the bank. In particular, prior transaction data involving the payer (e.g., the user of the user device 100), can be used to determine the genuineness score for the proposed wire transaction from the user/payer. In various embodiments, the database 122 may be implemented with a Mongo database (MongoDB), although other suitable database technologies could be used. MongoDB uses JSON-like documents with optional schemas.

The genuineness (or “authenticity”) computer system 126 may comprise, for example, a Spring Boot-developed application that communicates with the web server 106 via a risk engine API. The genuineness computer system 126 may communicate with the database server 120, via, for example, a Java database connectivity (JDBC) API.

Prior to deployment (and even after deployment as part of continual learning), the ML computer system 114 may be trained to recognize learned behavior patterns by machine learning training algorithms. In particular, the ML computer system 114 is trained, through machine learning, to determine a genuineness, or risk, of the user's proposed wire payment based on data from the API calls to the SWIFT network 134 and based on data in the database 122. The data from the API calls can include data from the pre-validation API calls and from the compliance analytics API calls to the SWIFT network 134. The ML model 114 can be trained on historical SWIFT network API call data and transaction data from the database 122 to learn the parameters for the model for computing the genuineness score for a wire transfer. In various embodiments, the ML model employs a liner regression model. The transactional history data from the database 122 used to train the model can include customer information, payment history, transaction history, and any other pertinent data regarding the payment sender.

The linear regression model can relate the value of a dependent variable Y (in this case, the genuineness of a wire payment) to a set of independent variables or features x₁₋ₙ (in this case, responses to the API calls and transaction data from the database 122) according to the equation Y=β₀+β₁x₁+β₂x₂+ . . . +βₙxₙ+e, where β₀₋ₙ are regression parameters that have to be learned from the training data. The quantity e is an error random variable (e.g., a residual) that has expected value 0. The ML model 114 can be trained so that the genuineness scores fall within a numerical range, such as from 0 to 100 (inclusive) or 0 to 1000 (inclusive), although other suitable ranges could be used.

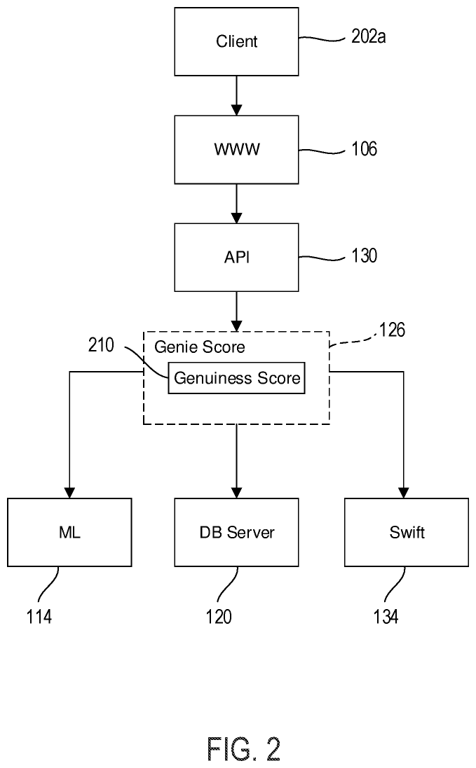

FIG. 2 illustrates an exemplary sequence 200 for computing the genuineness score with the bank computer system 101 in response to initiation of a wire payment request from a payer 202. The ML model 114 was previously trained to a suitable level prior to performance of the sequence. The payer 202 can be, for example, a financial institution, an organization or enterprise, or an individual, for example. The payer 202 initiates the wire payment via a website hosted by the web server 106. In other embodiments, the payer 202 may initiate the payment via an app, e.g., a mobile app, on the payer's device 100 that communicates with an application server of the bank computer system 101. Details of the requested payment, captured by the web server 106, are transmitted from the web server 106 to the genuineness computer system 126 via the risk API 132.

Next, the genuineness computer system 126 makes the API calls to the SWIFT network 134 to get the SWIFT network data from the proposed wire payment. The genuineness computer system 126 also requests, and is served, transaction data for the payer from the transaction database 122. The genuineness computer system 126 then forwards the data from the API calls and the database 122 to the ML model 114 for determination of the genuineness score 210 for the proposed wire payment. Based on the score value, the genuineness computer system 126 can generate a recommendation regarding the genuineness for the payment. As indicated above, the genuineness score 210 can map to one of three recommendations. If the genuineness score is below a first threshold value T₁, the proposed wire payment is unlikely to be genuine, corresponding to a red (or “stop” or to be rejected) indicator on the user interface for the transaction. If the genuineness score is above a second threshold T₂, wherein T₂>T₁, then the proposed wire payment is likely to be genuine, corresponding to a green (or “go” or proceed) indicator on the user interface for the transaction. If the genuineness score is greater than (or equal to) T1 and less than (or equal to) T2 (i.e., T₁≤Y≤T₂), then the proposed wire payment is unlikely to be genuine or counterfeit/fraudulent, e.g., it is indeterminate, which can correspond to a yellow (or “caution”) indicator on the user interface.

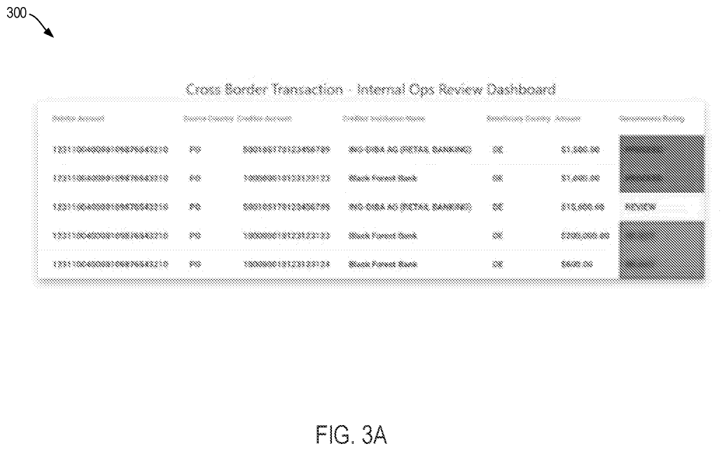

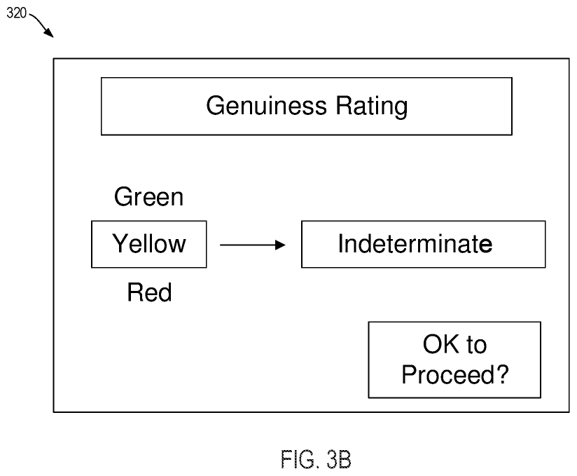

FIG. 3A illustrates an exemplary embodiment of a user interface for internal operations personnel with the bank associated with the bank computer system 101. The user interface shows several recent proposed wire payments for customers of the bank. Each proposed wire payment shows an account number for the payer, a country code for the payer, an account number for the payee, a financial institution name for the payee, and country code for the payee, a dollar amount for the proposed wire payment, and the genuineness rating. The internal operations user interface can be displayed on a web page that is available to authorized internal ops personnel of the bank. As seen in FIG. 3, each proposed wire transaction has been assigned with one of three genuineness ratings. A green rating indicates that the payment can proceed as intended. A yellow rating indicates that further review by the bank's internal operations team is recommended. A red score indicates that the payment should be rejected by the internal operations team of the bank.

FIG. 3B shows an exemplary embodiment of a user interface 320 for a payee. As seen in FIG. 3B, the proposed wire transaction has been assigned with one of three genuineness ratings. The user interface shows a recent proposed wire payments flagged as yellow for the payee's review. The user interface 320 indicates that the proposed wire payment was flagged as being indeterminate. As also seen in FIG. 3B, the user interface 320 comprises a button that asks the payee whether they would like to proceed with the payment.

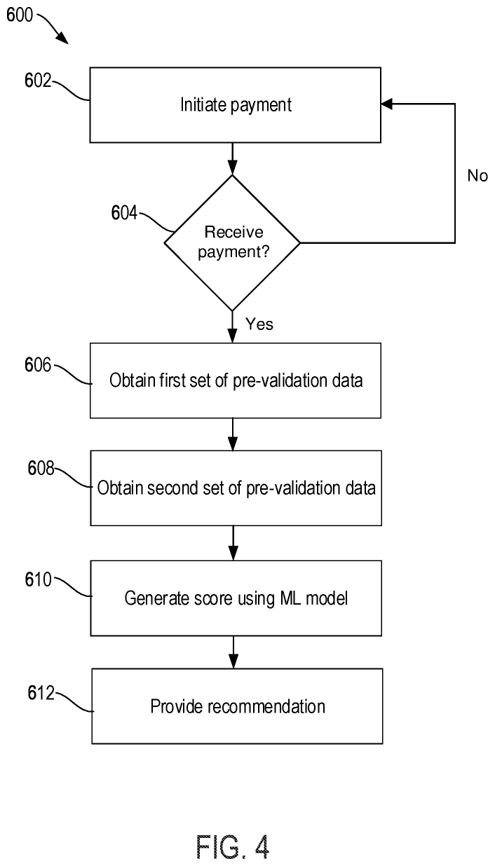

FIG. 4 illustrates a process 600 according to various embodiments of the present invention. At step 602, a user, or payer initiates a payment via the user device 100 by logging into the web server 106 to enter the details for the transaction, e.g., the payee, the amount, etc. At step 604, the web server 106 transmits the details for the transaction to the genuineness computer system 126 via an API. At step 606, the genuineness computer system 126 calls the SWIFT network 134 to obtain a first set of pre-validation data from the pre-validation API(s) for SWIFT® 134. At step 608, the genuineness computer system 126 calls the SWIFT® network 134 to obtain a second set of pre-validation data from the compliance analytics API(s) from SWIFT® 134. At step 609, the genuineness computer system 126 calls the database 122 to obtain transaction data for the payer for prior transactions involving the payer. For example, the transaction data includes customer historical transactions. The customer historical transactions include online requests and events or actions created from the online requests. The genuineness computer system 126 uses the customer historical transactions to determine anomalies. At step 610, the genuineness computer system 126 uses the already-trained machine learning model to compute the genuineness, or authenticity, score for the user's proposed transaction based on the data from the API calls to the SWIFT network 134 (e.g., steps 606 and 608) and based on the transaction data obtained at step 609. At step 612, the genuineness computer system 126 provides a genuineness rating for the payment based on the score. As indicated above, the genuineness rating can comprise one of three options. For example, if the genuineness score is greater than an upper threshold value (e.g., T₂), the rating can be “green” because the payment can proceed as intended. If the genuineness score is between (or equal to) the upper and lower thresholds (i.e., less than or equal to T₂ and greater than or equal to T₁), the rating can be “yellow,” meaning that further review is recommended by the bank's internal operations team. If the genuineness score is below the lower threshold (e.g., T₁), the rating can be “red,” meaning that the payment should be rejected by the intended recipient of the payment.

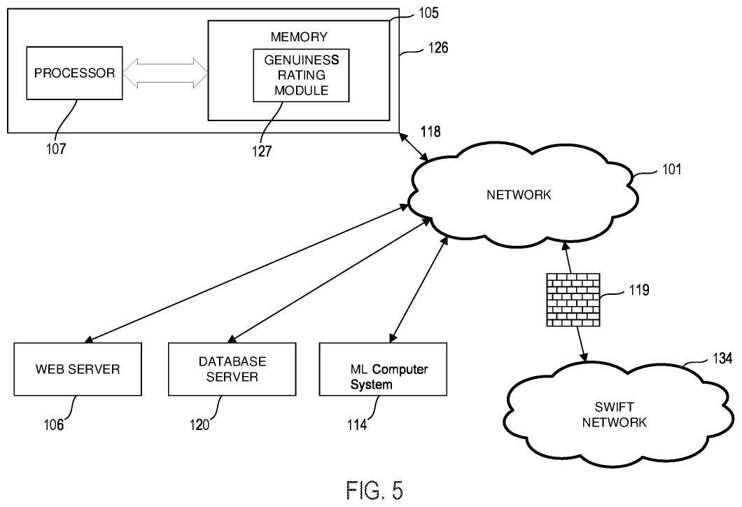

FIG. 5 shows an embodiment of a deployment computer system according to various embodiments. The deployment computer system deploys the ML model to determine the genuineness rating for the user's proposed wire payment after the ML model is trained to a suitable level, although the ML model can be continually trained even after deployment.

In the illustrated embodiment, the genuineness computer system 126 comprises one or more processors 107 and one or more computer memories 105. For simplicity, only one processor 107 and one computer memory 105 are shown in FIG. 5. The memory 105 stores a genuineness rating module 127, which comprises computer instructions, e.g., software, that is executed by the processor 107 to generate the genuineness rating as described herein. The illustrated computer system 10 includes an electronic data network 101, which can be implemented with, for example, an intranet, a LAN(s), and/or a WAN(s), for the bank or financial institution implementing the genuineness computer system 126. When the user requests a wired payment, the web server 106 can transmit details about the proposed wire payment to the genuineness computer system 126 via the network 101. The genuineness computer system 126 can then orchestrate determination of the genuineness score and rating as described herein. For example, the genuineness computer system 126 can make the API calls to the SWIFT network 134 to collect the API call data for the genuineness score. Note that the SWIFT network 134 is outside of the bank's internal data network 101. For example, bank's internal network 101 could be behind a firewall 119.

The genuineness computer system 126 can also make the database calls to the financial institution's backend database server 120 to get the data from the transaction database 122 to compute the genuineness score. Once the API call data from the SWIFT network 134 and transaction data from the transaction database 122 are collected, the genuineness computer system 126 (by executing the genuineness rating module 127 software) can pass, via the network 101, the data to the ML computer system 114 for determination of the genuineness score for the proposed transaction. The ML computer system 114 can then transmit, via the network 102, the computed genuineness score back to the genuineness computer system 126 for determination of the genuineness rating, which the genuineness computer system 126 can transmit to the web server 106 for delivery to the user/payer.

The memory 105 can include primary memory (e.g., memory directly accessible by the processor(s), such as RAM) and/or secondary memory (e.g., memory that is not directly accessible by the processors(s), such as ROM, flash, HDD, SSD, etc.). The genuineness rating module 127 stores computer instructions (e.g., software) that, when executed by the processor(s) 107, cause the processor(s) 210 to execute the process for orchestration generation of the genuineness rating as described above. The genuineness computer system 126 may be implemented as one or a number of networked computer devices, e.g., servers, laptops, PCs, for example.

The software for the various computer system described herein, including the genuineness rating module 127 of the genuineness computer system 126, and other computer functions described herein as discussed above may be implemented in computer software using any suitable computer programming language such as .NET, C, C++, Python, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C #, COBOL, Fortran, Java, Lisp, Pascal, Object Pascal, Haskell, ML; and examples of scripting languages include Bourne script, JavaScript, Python, Ruby, Lua, PHP, and Perl.

In various embodiments, therefore, the present invention is directed to a system and method for authenticating a proposed wire payment between a payer and a payee by a novel authentication process. The method may comprise training, by a training computer system, through machine learning, on a set of training data, a machine learning model to generate a genuineness score for a wire payment. The set of training data may comprise pre-validation data for payment transactions from an intra-bank payment network, compliance data, and user transaction history. The method may also comprise after training the machine learning model, determining, by a deployment computer system, a genuineness rating for a proposed wire payment from a payer to a payee. Determining the genuineness rating may comprise receiving, by the deployment computer system, the proposed wire payment from the payer, obtaining, by the deployment computer system, a first set of pre-validation data for the proposed wire payment from the intra-bank payment network, and obtaining, by the deployment computer system, a second set of data via internal compliance databases. Determining the genuineness rating may also comprise determining, by the deployment computer system, using the machine learning model, a genuineness score for the proposed wire payment based on the first set of data and the second set of data; and providing, by the deployment computer system, a genuineness rating for the proposed wire payment to the payer based on the genuineness score.

The intra-bank payment network may comprise a SWIFT® intra-bank payment network. The first set of data may comprise pre-validation analytics from the SWIFT® intra-bank payment network obtained using API calls to the SWIFT® intra-bank payment network. The first set of data may comprise compliance analytics from the SWIFT® intra-bank payment network obtained using API calls to the SWIFT® intra-bank payment network. The second set of data may comprise user transaction history information stored in a financial institution transaction database. A user interface may display the genuineness score rating in rating categories, wherein a first rating category signifies that the proposed wire payment can proceed, a second rating category signifies that the proposed wire payment should be reviewed, and a third rating category signifies that the proposed wire payment should be rejected. The machine learning model may comprise a linear regression model.

In various embodiments, the present invention is directed to a method which may comprise training, by a training computer system, through machine learning, on a set of training data, a machine learning model to generate a genuineness score for an electronic payment transfer, wherein the set of training data may comprise pre-validation data for payment transactions from an intra-bank payment network, compliance data, and user transaction history.

The method may also comprise after training the machine learning model, determining, by a deployment computer system, a genuineness rating for a proposed electronic payment transfer from a payer to a payee. Determining the genuineness rating may comprise receiving, by the deployment computer system, the proposed electronic payment transfer from the payer, obtaining, by the deployment computer system, a first set of pre-validation data for the proposed electronic payment transfer from the intra-bank payment network, and obtaining, by the deployment computer system, a second set of data via internal compliance databases. The method may also comprise determining, by the deployment computer system, using the machine learning model, a genuineness score for the proposed electronic payment transfer based on the first set of pre-validation data and the second set of pre-validation data, and providing, by the deployment computer system, a recommendation for the proposed electronic payment transfer to the payer based on the genuineness score.

The intra-bank payment network may comprise a SWIFT® intra-bank payment network. The first set of data may comprise pre-validation analytics from the SWIFT® intra-bank payment network obtained using API calls to the SWIFT® intra-bank payment network. The first set of data may also comprise compliance analytics from the SWIFT® intra-bank payment network obtained using API calls to the SWIFT® intra-bank payment network. The second set of data may comprise user transaction history information stored in a financial institution backend database. A user interface may display the genuineness score rating in rating categories, wherein a first rating category signifies that the proposed electronic payment transfer can proceed, a second rating category signifies that the proposed electronic payment transfer should be reviewed, and a third rating category signifies that the proposed electronic payment transfer should be rejected. The machine learning model may comprise a linear regression model

In various embodiments, the present invention is directed to a computer system which may comprise a machine learning (ML) computer system that is trained, through machine learning, on a set of training data, to generate, with a machine learning model, a genuineness score for a wire payment, wherein the set of training data comprises pre-validation data for payment transactions from an intra-bank payment network, compliance data, and user transaction history. The computer system may also comprise a genuineness computer system in communication with the ML computer system, wherein the genuineness computer system is for determining a genuineness rating for a proposed wire payment from a payer to a payee and The genuineness computer system is configured to determine the genuineness rating for the proposed wire payment by receiving, via the payer, data regarding the proposed wire payment, obtaining a first set of pre-validation data for the proposed wire payment from the intra-bank payment network, and obtaining a second set of data from a transaction database. The computer system is also configured to determine the genuineness rating for the proposed wire payment by passing the first set of pre-validation data and the second set of data to the ML computer system, and receiving, from the ML computer system, the genuineness score for the proposed wire payment, wherein the ML computer system determines the genuineness score using the machine learning model, and determining the genuineness rating from the genuineness score.

The intra-bank payment network may comprise a SWIFT® intra-bank payment network. The genuineness computer system may be configured to make the following API calls to the SWIFT® intra-bank payment network to obtain the first set of pre-validation data for the proposed wire payment:
swift-preval-pilot/v2/payment/account-format;
swift-preval-pilot/v2/accounts/verification;
swift-preval-pilot/v2/payment/financial-institution-identity;
swift-preval-pilot/v2/payment/purpose-code;
swift-preval-pilot/v2/payment/payment-purpose; and
swift-preval-pilot/v2/payment/category-purpose.

The genuineness computer system may further be configured to determine the genuineness rating for the proposed wire payment by obtaining a third set of compliance analytics data for the proposed wire payment from the SWIFT intra-bank payment network by making a compliance analytics API call to the SWIFT intra-bank payment network. The ML computer system may be further trained to determine the ML score based on data from a compliance analytics API call to the SWIFT intra-bank payment network. The ML model may comprise a linear regression model.

In various embodiments, the present invention may comprise a computer system comprising first means that are trained, through machine learning, on a set of training data, to generate, with a machine learning model, a genuineness score for a wire payment, wherein the set of training data comprises pre-validation data for payment transactions from an intra-bank payment network, compliance data, and user transaction history, and second means for determining a genuineness rating for a proposed wire payment from a payer to a payee. The second means for determining the genuineness rating for the proposed wire payment by receiving, via the payer, data regarding the proposed wire payment, obtaining a first set of pre-validation data for the proposed wire payment from the intra-bank payment network and obtaining a second set of data from a transaction database. The second means for determining the genuineness rating can also comprise passing the first set of pre-validation data and the second set of data to the first means, receiving, from the first means, the genuineness score for the proposed wire payment, wherein the first means determines the genuineness score using the machine learning model, and determining the genuineness rating from the genuineness score.

The intra-bank payment network may comprise a SWIFT® intra-bank payment network. The second means may be configured to make the following API calls to the SWIFT® intra-bank payment network to obtain the first set of pre-validation data for the proposed wire payment:
swift-preval-pilot/v2/payment/account-format;
swift-preval-pilot/v2/accounts/verification;
swift-preval-pilot/v2/payment/financial-institution-identity;
swift-preval-pilot/v2/payment/purpose-code;
swift-preval-pilot/v2/payment/payment-purpose; and
swift-preval-pilot/v2/payment/category-purpose; and
the ML model comprises a linear regression model.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

1. A method comprising:
training, by a training computer system, through machine learning, on a set of training data, a machine learning model to generate a genuineness score for a wire payment, wherein the set of training data comprises pre-validation data for payment transactions from an intra-bank payment network, compliance data, and user transaction history;
after training the machine learning model, determining, by a deployment computer system, a genuineness rating for a proposed wire payment from a payer to a payee, wherein determining the genuineness rating comprises:
receiving, by the deployment computer system, the proposed wire payment from the payer;
obtaining, by the deployment computer system, a first set of pre-validation data for the proposed wire payment from the intra-bank payment network;
obtaining, by the deployment computer system, a second set of data via internal compliance databases;
determining, by the deployment computer system, using the machine learning model, a genuineness score for the proposed wire payment based on the first set of data and the second set of data; and
providing, by the deployment computer system, a genuineness rating for the proposed wire payment to the payer based on the genuineness score.

2. The method of claim 1, wherein the intra-bank payment network comprises a SWIFT® intra-bank payment network.

3. The method of claim 2, wherein the first set of data comprises pre-validation analytics from the SWIFT® intra-bank payment network obtained using API calls to the SWIFT® intra-bank payment network.

4. The method of claim 2, wherein the first set of data comprises compliance analytics from the SWIFT® intra-bank payment network obtained using API calls to the SWIFT® intra-bank payment network.

5. The method of claim 1, wherein the second set of data comprises user transaction history information stored in a financial institution transaction database.

6. The method of claim 1, wherein a user interface displays the genuineness score rating in rating categories, wherein a first rating category signifies that the proposed wire payment can proceed, a second rating category signifies that the proposed wire payment should be reviewed, and a third rating category signifies that the proposed wire payment should be rejected.

7. The method of claim 1, wherein the machine learning model comprises a linear regression model.

8. (canceled)

9. The method of claim 22, wherein the intra-bank payment network comprises a SWIFT® intra-bank payment network.

10. The method of claim 9, wherein the first set of data comprises pre-validation analytics from the SWIFT® intra-bank payment network obtained using API calls to the SWIFT® intra-bank payment network.

11. The method of claim 9, wherein the first set of data comprises compliance analytics from the SWIFT® intra-bank payment network obtained using API calls to the SWIFT® intra-bank payment network.

12. The method of claim 22, wherein the second set of data comprises user transaction history information stored in a financial institution backend database.

13. The method of claim 22, wherein a user interface displays the genuineness score rating in rating categories, wherein a first rating category signifies that the proposed wire payment can proceed, a second rating category signifies that the proposed wire payment should be reviewed, and a third rating category signifies that the proposed wire payment should be rejected.

14. The method of claim 22, wherein the machine learning model comprises a linear regression model.

15. A computer system comprising:
a machine learning (ML) computer system that is trained, through machine learning, on a set of training data, to generate, with a machine learning model, a genuineness score for a wire payment, wherein the set of training data comprises pre-validation data for payment transactions from an intra-bank payment network, compliance data, and user transaction history; and
a genuineness computer system in communication with the ML computer system, wherein the genuineness computer system is for determining a genuineness rating for a proposed wire payment from a payer to a payee, wherein the genuineness computer system is configured to determine the genuineness rating for the proposed wire payment by:
receiving, via the payer, data regarding the proposed wire payment;
obtaining a first set of pre-validation data for the proposed wire payment from the intra-bank payment network;
obtaining a second set of data from a transaction database;
passing the first set of pre-validation data and the second set of data to the ML computer system;
receiving, from the ML computer system, the genuineness score for the proposed wire payment, wherein the ML computer system determines the genuineness score using the machine learning model; and
determining the genuineness rating from the genuineness score.

16. The computer system of claim 15, wherein the intra-bank payment network comprises a SWIFT® intra-bank payment network.

17. The computer system of claim 16, wherein the genuineness computer system is configured to make the following API calls to the SWIFT® intra-bank payment network to obtain the first set of pre-validation data for the proposed wire payment:
swift-preval-pilot/v2/payment/account-format;
swift-preval-pilot/v2/accounts/verification;
swift-preval-pilot/v2/payment/financial-institution-identity;
swift-preval-pilot/v2/payment/purpose-code;
swift-preval-pilot/v2/payment/payment-purpose; and
swift-preval-pilot/v2/payment/category-purpose.

18. The computer system of claim 17, wherein:
the genuineness computer system is further configured to determine the genuineness rating for the proposed wire payment by obtaining a third set of compliance analytics data for the proposed wire payment from the SWIFT intra-bank payment network by making a compliance analytics API call to the SWIFT intra-bank payment network;
the ML computer system is further trained to determine the ML score based on data from a compliance analytics API call to the SWIFT intra-bank payment network.

19. The computer system of claim 18, wherein the ML model comprises a linear regression model.

20. A computer system comprising:
first means that are trained, through machine learning, on a set of training data, to generate, with a machine learning model, a genuineness score for a wire payment, wherein the set of training data comprises pre-validation data for payment transactions from an intra-bank payment network, compliance data, and user transaction history; and
second means for determining a genuineness rating for a proposed wire payment from a payer to a payee, wherein the second means determines the genuineness rating for the proposed wire payment by:
receiving, via the payer, data regarding the proposed wire payment;
obtaining a first set of pre-validation data for the proposed wire payment from the intra-bank payment network;
obtaining a second set of data from a transaction database;
passing the first set of pre-validation data and the second set of data to the first means;
receiving, from the first means, the genuineness score for the proposed wire payment, wherein the first means determines the genuineness score using the machine learning model; and
determining the genuineness rating from the genuineness score.

21. The computer system of claim 20, wherein:
the intra-bank payment network comprises a SWIFT® intra-bank payment network;
the second means is configured to make the following API calls to the SWIFT® intra-bank payment network to obtain the first set of pre-validation data for the proposed wire payment:
swift-preval-pilot/v2/payment/account-format;
swift-preval-pilot/v2/accounts/verification;
swift-preval-pilot/v2/payment/financial-institution-identity;
swift-preval-pilot/v2/payment/purpose-code;
swift-preval-pilot/v2/payment/payment-purpose; and
swift-preval-pilot/v2/payment/category-purpose; and
the ML model comprises a linear regression model.

22. The method of claim 1, further comprising, providing, by the deployment computer system, a recommendation for the proposed wire payment transfer to the payer based on the genuineness score.
